(19) United States
(12) Patent Application Publication
(10) Pub. No.: US 2012/0027555 A1
(43) Pub. Date: Feb. 2, 2012

(54) PALLETIZER WITH BOX LAYER PREPARATION

(75) Inventors: Dominique Germain, Octeville-Sur-Mer (FR); Fabrice Sauvageot, Octeville-Sur-Mer (FR)

(73) Assignee: SIDEL PARTICIPATIONS, Octeville-Sur-Mer (FR)

(21) Appl. No.: 13/259,265

(22) PCT Filed: Mar. 25, 2010
(86) PCT No.: PCT/FR10/50540

§ 371 Date: Sep. 23, 2011

(30) Foreign Application Priority Data
Mar. 27, 2009 (FR) 09 01495

(51) Int. Cl. B65G 57/24

(52) U.S. Cl. 414/791.6; 414/802

(57) ABSTRACT

The invention relates to a palletizer including a device (24) for preparing and prestacking layers of boxes, said device consisting of: a vertically moveable table (25); two tables (26, 26′) forming a noria and capable of alternately taking the place of said table (25) and of depositing another layer of boxes onto the layer standing by on said table (25); a means for calibrating each layer of boxes according to the palletization scheme. The table (25) and the table (26, 26′) are used to perform the operation of calibrating the layers of boxes by moving said boxes against an abutment (40) which, in an inoperative position, acts as a slider bed between the table (25) and the palletization table (7). The table (26, 26′) consists of rollers (30) which are mounted on one-way bearings.

The present invention relates to palletization installations and, more particularly, a palletizer which comprises a device for preparing and prestacking layers of boxes or other items (packs, partitions, trays etc.) before they are deposited on a pallet.

In this palletization field, the palletizer is part of what is called the end of line, i.e. it receives boxes of products which are leaving a packaging installation at a certain rate, which rate is itself very often set by the rates of the preceding installations where the preparation and production of these products to be palletized are carried out.

In this context, the palletizer must respond to all sorts of constraints: firstly,—constraints linked to the nature of the products which are more or less fragile, more or less stable and more or less regular,—constraints linked to the rates as it is not conceivable to stop a complete production line outside of the stops which have been expressly programmed, and—constraints linked to the immediate surroundings of the palletizer such as the surface area available for its installation, for example.

It is known, as described in document DE 25 11 207, to prepare a pair of layers of boxes in order to improve palletization rates. The first layer is prepared at a station which is situated upstream of the palletization station and is lifted up by an appropriate device while a second layer is prepared. As soon as this second layer is ready, the first layer is deposited on the second and the two layers are conveyed to a station where they are picked up by a carriage which transfers them to the actual palletization station. The two layers are retained by a barrier while the carriage returns to its position for picking up another group of layers and they are automatically deposited, by gravity alone, onto the pallet or onto the layers already in place on said pallet.

It is also known, as described in document FR 2 861 714, to prepare several layers of products and to delay their palletization during the pallet-changing operation which constitutes dead time in the palletization cycle.

The different layers of products are prepared directly at the palletization station on pre-grouping tables which are superimposed vertically above the pallet to be loaded and these layers are left standing by during the pallet-changing time, i.e. during the operations of removing the pallet which is full and the setting up of a new pallet.

These different layers which are standing by are then deposited, in turn, on the new empty pallet, at the palletization station.

Document FR 2 897 341 describes a palletizer which itself also responds to some of the constraints described in detail above and, in particular, to the constraints linked to the nature of the products; it is arranged so as to allow the preparation of pallets with boxes containing relatively fragile products such as, for example, bottles.

This palletizer is arranged so as to gently carry out the operations of grouping together the boxes of products which involve boxes coming in contact with each other such as, in particular, operations which consist of grouping together the boxes which are in the form of rows so as to reassemble them in the form of layers, which layers are then transferred onto a palletization table which is responsible for depositing each layer onto the pallet provided for this purpose.

However, with the increase in the rates of production of the products and of the rates of packaging of these products, it is noted that, at a palletization station, the time which is required to complete the operation of removing a full pallet, added to the time required for the operation of setting up a new empty pallet, is much greater than the time needed to prepare a layer of boxes, and this is holding up the improvement in rates.

This time constraint, at the palletization station, determines the organization of the entire palletization installation; in terms of rates, it is therefore the palletization station which determines the rates upstream, i.e. the rate of preparation of the layers of boxes and also the rate at which these boxes arrive on the palletizer.

For certain palletization installations, where the constraints linked to the installation of the palletizer are severe, the time required for the operations of moving the pallets, full or empty, can be relatively significant, for example, because of the need to carry out changes in the orientation of the pallets.

Moreover, the table of the palletization station itself has its own rates and these are linked to the different operations which are carried out by this depositing or palletization table. Nowadays this depositing, or palletization, table, is in fact multifunctional and it carries out operations which will to a certain extent disturb its cycle and slow down its rate.

This table can in fact be used to create and align the adjacent layers which are superimposed on the pallet, which operation is, for example, carried out by means of longitudinal and transverse cleats, or pressers, arranged directly on said table. For this operation, which takes a certain time, the table starts by depositing the layer of boxes on the pallet, then it shifts vertically downwards so as to place the different pressers at an intermediate level, between two layers, so as to align the sides of these two superimposed layers.

This table can also be put on standby when the layers of boxes etc. have to be separated by an interlayer. This interlayer-insertion operation, which is carried out by appropriate equipment associated with the palletization station, has the effect of reducing the rate of the palletization table.

The document GB 1 129 944 describes a compact palletizer which comprises a combined station for the preparation of the layers of boxes and for palletization of these layers, as they are prepared. The first layer is prepared on a retractable table with means for calibration and means for adjustment of the position of the boxes relative to each other.

When the layer is ready, the preparation table is retracted and the prepared layer retained by a transverse abutment and, depending on the case, by the calibration structure, is placed directly on the pallet which is standing by under said preparation table, or is deposited on the layer previously deposited on said pallet, which pallet is borne by a lifting table which picks up the pallet for the time taken to load it.

The table for the preparation of the layers is constituted by slats and is mounted on chains which surround the lifting table of the palletization station, and which surround the pallet with its load. The chains in fact comprise two tables constituted by slats, which tables are relayed in order to pick up each layer of boxes and they form a kind of noria around the lifting table which bears the pallet to be loaded.

The present invention proposes, for a palletization installation of the type described in the abovementioned document FR 2 897 341, the use of means of the type of those which are described in the abovementioned document GB 1 129 944 so as to delay sending the boxes to the palletization station for the time which is necessary to complete all the operations linked to this palletization station.

The present invention makes it possible to improve the operation and the capacities of the palletization table without modifying its rate which is generally of the order of six operations, on average, per minute. It also makes it possible to reduce the stresses on this palletization table while improving its flow rate thanks to suitable preparation of the boxes to be palletized.

Moreover, the equipment used, as described in the abovementioned document FR 2 897 341, allows manipulation of relatively fragile boxes and products.

The present invention therefore proposes a palletizer constituted by a preparation zone which comprises a conveyor for conveying the boxes, a station for the preparation of the groups or rows of boxes and a station for the preparation of each layer of boxes and by a zone for the actual palletization which comprises the palletization station and the deck, or deposit table, and this palletizer also comprises pushers for moving said boxes from one zone to the other, i.e. from said preparation zone towards said palletization zone and it comprises a conveyor for conveying pallets to said palletization station, which palletizer comprises a specific station for box layer preparation which is constituted by a buffer device equipped, on the one hand,—with means for preparing a first layer of boxes, for calibrating it and for moving it in order to leave room for—additional means which will, in the same way, prepare another layer of boxes and calibrate it and, on the other hand, with means for stacking said other layer of boxes on the previous layer and so on, so as to delay the transfer of these different layers towards the palletization station for a period of time which is at least equal to that which is necessary to carry out the different operations which take place at said palletization station, such as the pallet-changing operations, and/or the insertion of an interlayer between two layers, and/or of jogging in order to align the layers, for example, which box layer preparation device being associated with one of said pushers in order finally to move this stack of layers of boxes towards the palletization zone and in particular onto the deposit table of said palletization station.

According to a preferential arrangement of the invention the device of the station for the preparation and pre-stacking of each layer of boxes comprises:
means for preparing a first layer of boxes, for calibrating it and for keeping it temporarily at the preparation station while moving it, which means are constituted by a main table which is vertically moveable between—a high position for receiving the rows of boxes in order to form a layer of boxes and—a low position which is situated at a distance corresponding substantially to the thickness of said layer of boxes, for receiving another layer of boxes, which calibration means are constituted by lateral cleats and a retractable transverse abutment for calibrating the layer of boxes at said preparation post, said main table being constituted by a motorized endless belt, which belt is used in particular for moving the boxes and for pressing them against the transverse abutment in order to calibrate said layer of boxes in the longitudinal direction.
means for preparing and calibrating another layer of boxes which are constituted by at least two interim tables capable of taking the place, in turn, of the main table when the latter is in the low position, which interim tables are horizontally moveable in the plane of circulation of the boxes, guided between an operative position of occupation of the window left free by said main table, in order to receive groups or rows of boxes and allow a new layer of boxes to be formed, and an inoperative position that they reach by being retracted and by being separated from said new layer, the latter being deposited on the layer which is standing by on said main table, said depositing taking place automatically, by gravity alone, as the interim table which is in operation is retracted,
a first pusher which moves the groups or rows of boxes between said station for preparing the groups or rows and the station for preparing the layers,
a second pusher which moves the layer or layers of boxes between said preparation station and said palletization station.

Still according to the invention, the device for preparing and for prestacking the layers of boxes comprises two identical interim tables which are each constituted by a flexible panel produced with rollers with a small diameter, mounted with a free wheel, which interim tables are arranged opposite each other, on endless chains, and the assembly forms a kind of noria around the main table, which endless chains are positioned laterally, on either side of the preparation station, each guided in a frame which extends around said main table, and the free space between the two interim tables corresponds at least to the length of the receiving surface area of said main table in order to allow the latter to pass through and be placed in the operative position for receiving a group of boxes, which endless chains are moved sequentially forwards in a direction which corresponds to the direction of advance of the layers of boxes towards the palletization station.

According to another arrangement of the invention, the rollers of each interim table are mounted on bearings comprising a free wheel so as to allow the boxes to be carried along during the movement of said table and for pushing or pressing said boxes against the transverse abutment in order to automatically calibrate the layer of boxes, in the longitudinal direction of circulation of said boxes on said interim table, according to the palletization scheme, as said rollers are retracted during the depositing of this layer of boxes on the lower layer of boxes which is situated on the main table.

Still according to the invention, the palletizer comprises means for calibrating each layer of boxes according to the palletization scheme, directly on said main table and, depending on the case, on the interim table, which means are constituted, on the one hand, by the retractable abutment which is arranged transversally with respect to the direction of travel of the boxes on the station for preparing the layers of boxes and at the downstream end of said preparation station and, on the other hand, by cleats arranged laterally on each side of said station for preparing the layers, which transverse abutment is arranged and positioned in such a way that in the inoperative position it acts as a slider bed joining the main table and the deposit table of the palletization station.

According to another arrangement of the invention, the main table comprises a support which is borne by a cradle, which cradle extends transversally beyond the frames of the noria, guided vertically on posts which form a general chassis on which said frames of the noria are fixed, and this cradle is maneuvered in the vertical direction by means of a mechanism integrated into said posts of said chassis and, in particular, a mechanism constituted by chains which are arranged in the side posts of the chassis, said endless chains being driven by a common servomotor.

This device for preparing and stacking layers of boxes can also, preferentially, be presented in the form of a module which can be inserted between the station for preparing groups, or rows, of boxes and the palletization station, which module comprises:
a main table which is vertically moveable from a high position for preparing the first layer of boxes to a low position, standing by for another layer of boxes, which main table is constituted by a motorized endless belt used in particular for setting the boxes in motion and, in particular, for pressing them in order to calibrate the layer of boxes in the longitudinal direction of circulation of said boxes,
means constituted by lateral cleats and a retractable transverse abutment for calibrating the layer of boxes,
at least two interim tables capable, in turn, of taking the place of the main table when the latter is in the low position with one or more layers of boxes, which interim tables are horizontally moveable, guided between an operative position of occupation of the window left free by said main table, in order to receive groups or rows of boxes and allow a new layer of boxes to be formed, and an inoperative position that they reach by being retracted and by being separated from said new layer, the latter being deposited on the layer which is present on said main table, said depositing taking place automatically, by gravity alone, as the interim table which is in operation is retracted.

Still according to the invention the module for preparing and stacking of layers of boxes comprises two identical interim tables which are each constituted by a flexible panel produced with rollers with a small diameter, mounted on a free wheel, which interim tables are mounted opposite each other, on endless chains, and the assembly forms a kind of noria, which endless chains are arranged laterally, guided in a frame which extends around the main table, and the free space between the two panels corresponds at least to the length of the receiving surface area of said main table in order to allow the latter to pass through and be placed in the operative position for receiving rows of boxes, which endless chains are moved sequentially forwards in a direction which corresponds to the direction of advance of the layers of boxes towards the palletization station.

According to another arrangement of the invention, the rollers of the interim table are mounted on bearings comprising a free wheel so as to set the boxes in motion and press them against the transverse abutment in order to automatically calibrate the layer of boxes according to the palletization scheme, as said rollers are retracted during the depositing of this layer of boxes on the layer of boxes which is situated on the main table.

Still according to the invention, the module for preparing and stacking layers of boxes also comprises means for calibrating each layer of boxes according to the palletization scheme, which means are constituted, on the one hand, by a retractable abutment which is arranged transversally, at the downstream end of said module, and on the other hand by cleats arranged laterally on each side; which transverse abutment, in the inoperative position, acts as a slider bed joining the main table and the table of the palletization station.

According to another arrangement of the invention, the main table comprises a support which is borne by a cradle, which cradle extends transversally beyond the frames of the noria, and it is guided vertically on posts which form part of the general chassis on which said frames of the noria are fixed, and this cradle is maneuvered in the vertical direction by means of a mechanism which is constituted by chains which are firmly fixed to said cradle, said chains are arranged in the side posts which form part of the chassis, they are driven by a common servomotor.

The invention also relates to the method for preparing and prestacking these layers of boxes which makes it possible to delay the operation of palletizing these different layers on a palletizer, which method consists of:
preparing a layer of boxes on the main table of the preparation and stacking module, from a previously formed group of boxes;
calibrating this layer of boxes according to the palletization scheme and putting it into the format of a receiving pallet, on said main table;
vertically retracting said main table, by a height substantially greater than the thickness of the layer of boxes;
installing an interim table in the space left free by said main table;
conveying a new group of boxes onto said interim table and calibrating in the same way as the previous layer and vertical to this previous layer;
retracting said interim table keeping the corresponding layer of boxes framed in order to deposit it directly on the previous layer which is arranged on said main table, at a lower level;
once there is no longer any need for delay, bringing the main table back to the level of the palletization table, with its different superimposed layers of boxes; and,
transferring said superimposed layers of boxes to said palletization station in order to deposit them on said pallet.

According to another arrangement of the invention, the pre-stacking method consists of simultaneously carrying out,—the transfer of the superimposed layers of boxes towards the palletization station and,—the setting up of new rows of boxes on the main table for formation of the initial layer of boxes.

Still according to the invention, in order to carry out the calibration of each layer of boxes, the pre-stacking method consists of:
stopping the boxes on the transverse abutment situated at the downstream end of the device or of the preparation and stacking module in order to longitudinally press said boxes by means of each layer-preparation table,
transversally pressing the boxes constituting each layer, by means of lateral cleats bordering said layer-preparation device, which cleats are moveable above the table which bears the corresponding layer and,
longitudinally pressing said boxes by means of the corresponding table, under the effect of the adherence between the different boxes and said corresponding table, by a longitudinal movement of the corresponding table in a direction from the table for preparing the rows of boxes towards the palletization station.

The invention is described in further detail by means of the following description and attached drawings, given by way of illustration and in which:

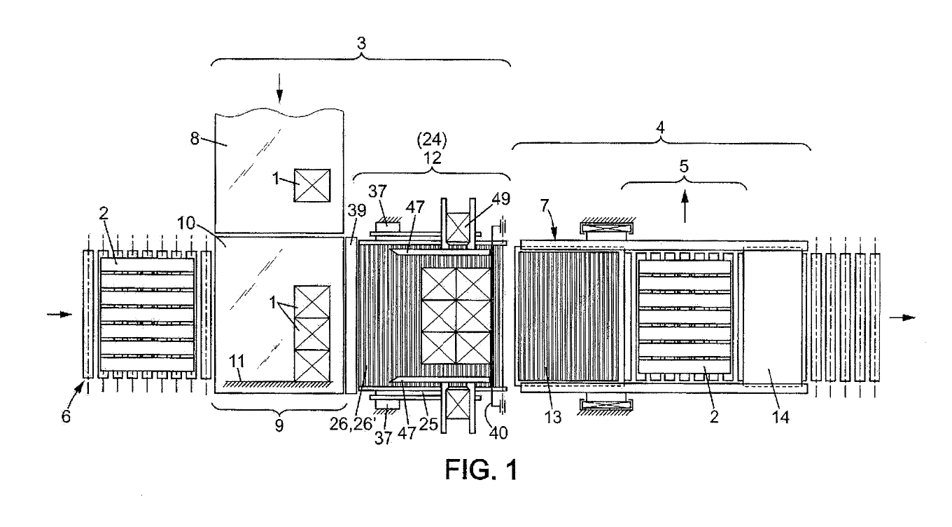

FIG. 1 is a diagrammatic plan view of the palletization installation which comprises a station equipped with the preparation and stacking device according to the invention;

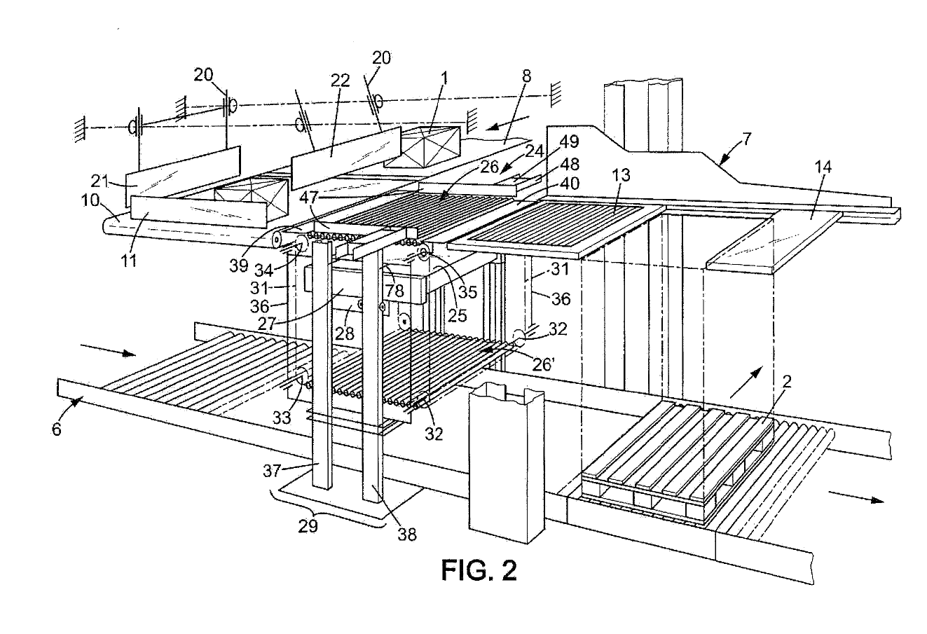

FIG. 2 is a diagrammatic and simplified perspective view of a palletization installation which comprises the device for preparing and stacking layers of boxes with the system in the form of a noria which comprises the interim tables;

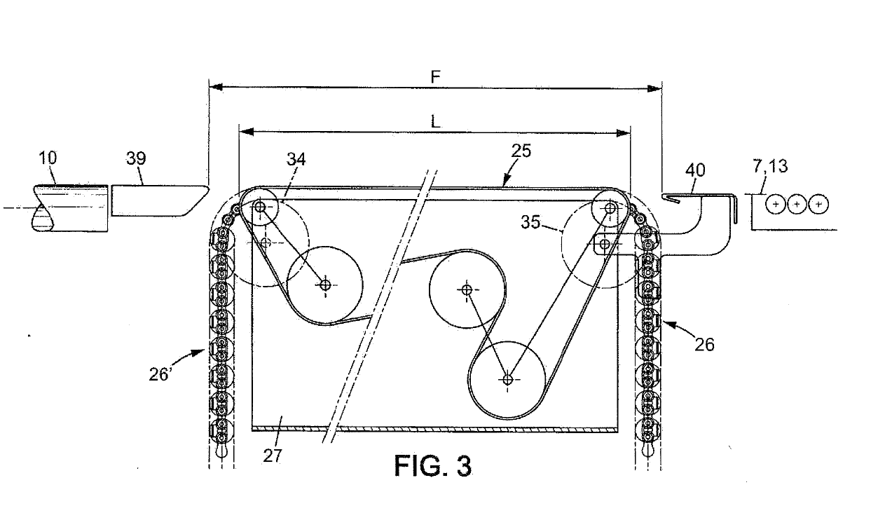

FIG. 3 shows, still diagrammatically, the main table for preparing and stacking layers, in the operative position, after the transfer of the layer or layers of boxes;

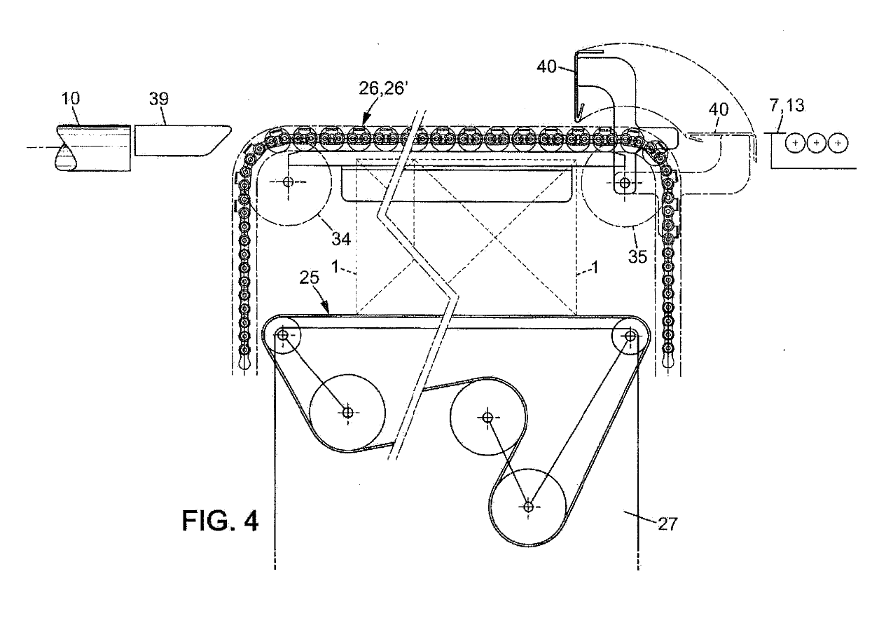

FIG. 4 is also a diagrammatic view showing the main table in the inoperative position and an interim table, which interim table is formed by a flexible panel constituted by rollers and it is in the operative position for receiving a group of boxes in order to form a layer;

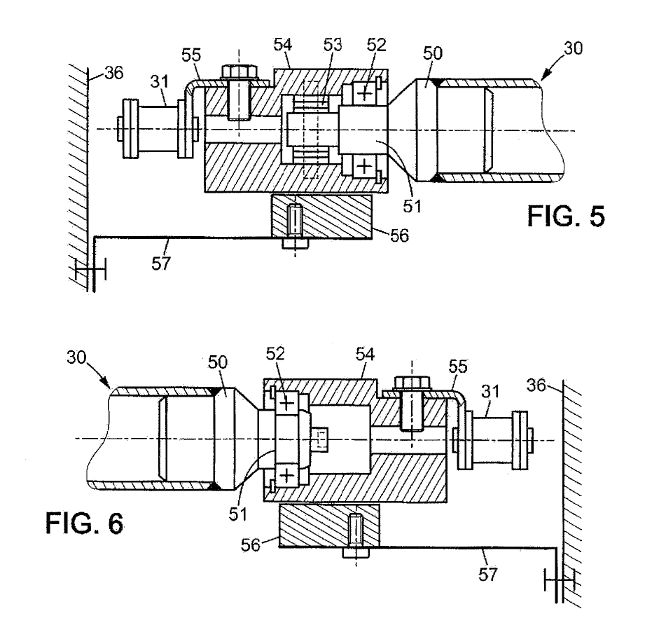

FIG. 5 shows, in cross-section, one of the ends of a roller of the interim table;

FIG. 6 shows, also in cross-section, the other end of a roller of the interim table;

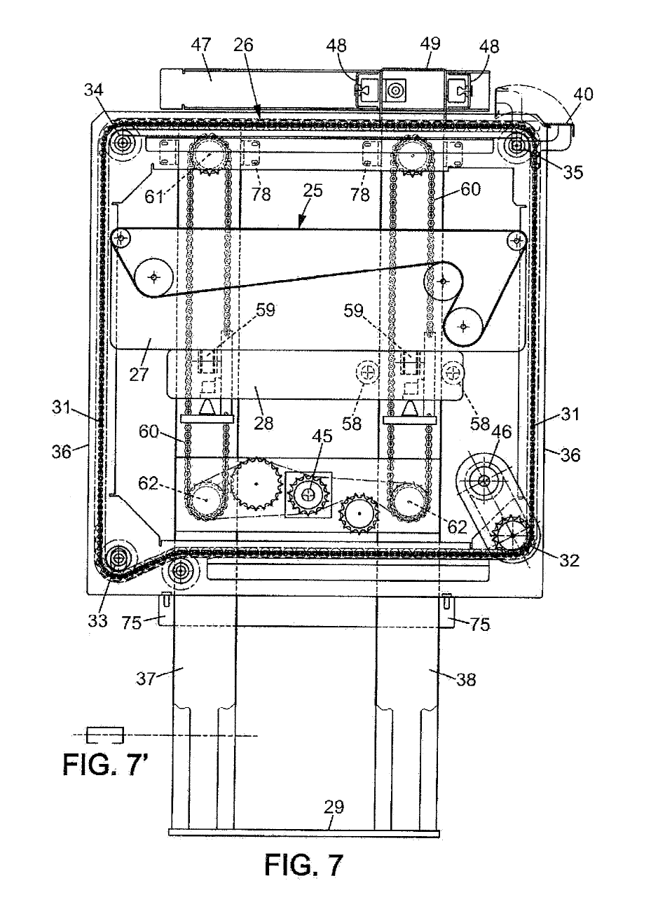

FIG. 7 is an elevation of the station for preparing and stacking layers of boxes, viewed from the side;

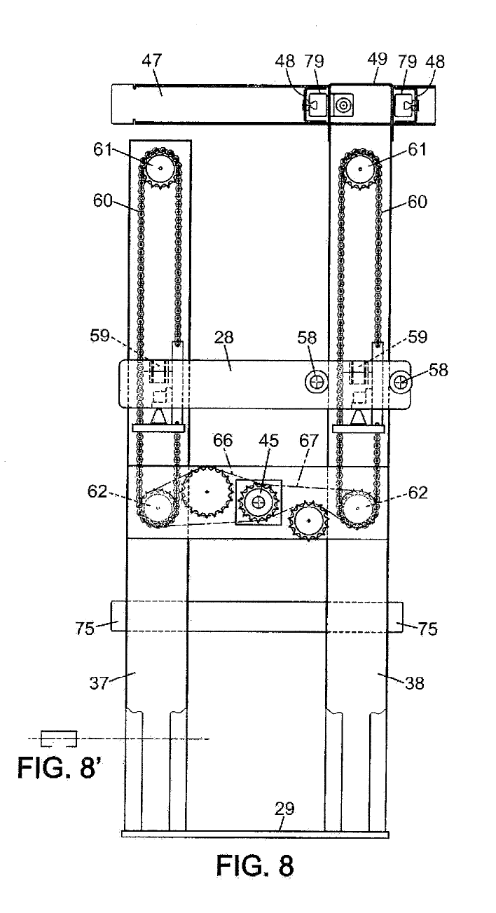

FIG. 8 is an elevation of the chassis of the preparation and stacking station, said chassis being represented without the noria, and without the main table;

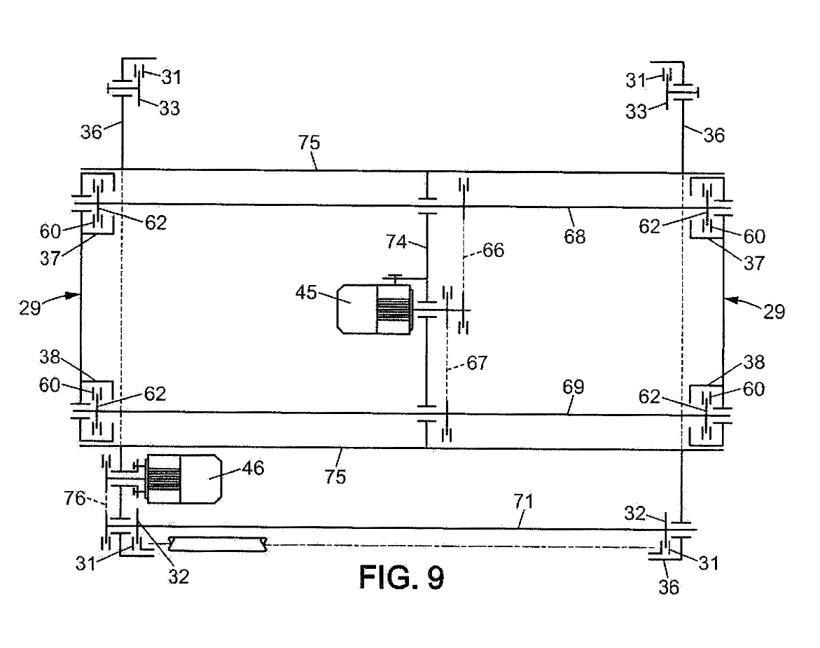

FIG. 9 is a plan view showing the arrangement of the different control components of the noria and of the cradle of the main table;

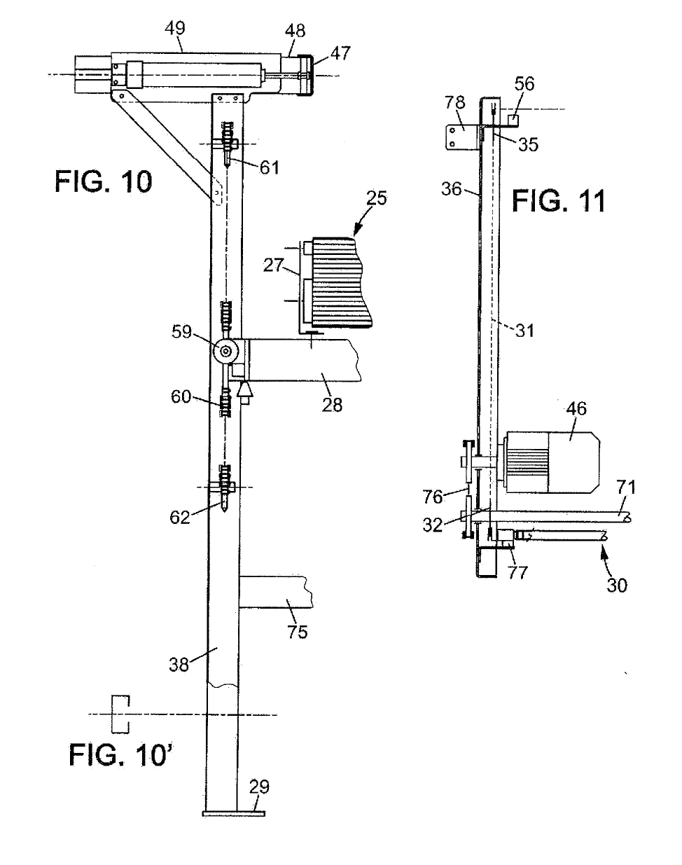

FIG. 10 is an elevation of the chassis of the layer-preparation station, showing the cradle of the main table with a portion of this main table;

FIG. 11 is a partial diagrammatic elevation of the noria, viewed from the front;

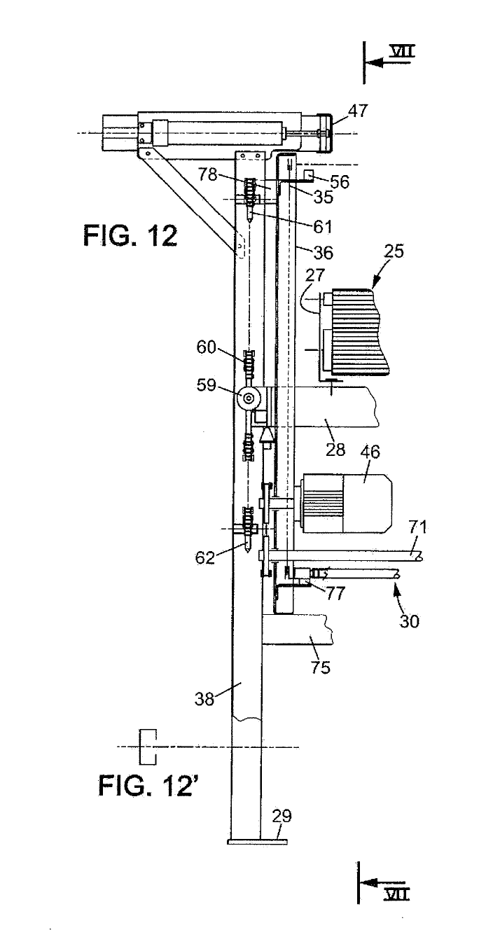

FIG. 12 is a diagrammatic elevation, viewed from the front, of one side of the chassis on which the frame of the noria has also been mounted, as shown in FIG. 11;

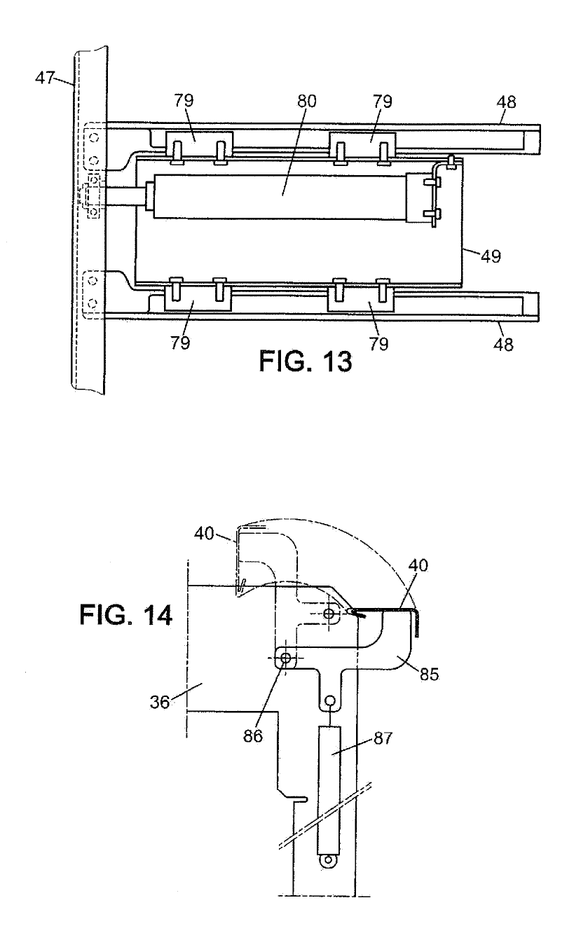

FIG. 13 is a plan view of one of the cleats which are arranged laterally with its means of implementation for pressing the boxes in the transverse direction;

FIG. 14 diagrammatically shows the transverse abutment which carries out the longitudinal confinement of the boxes, which transverse abutment is represented in bold lines in the inoperative abutment position, acting as a slider bed, and in fine dot-and-dash lines in the operative abutment position;

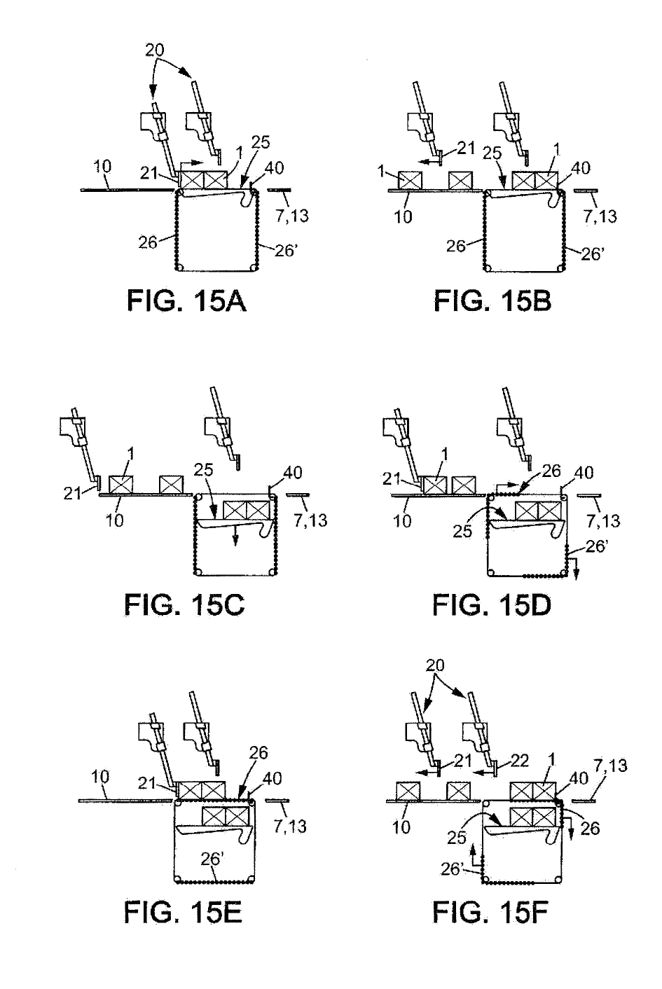

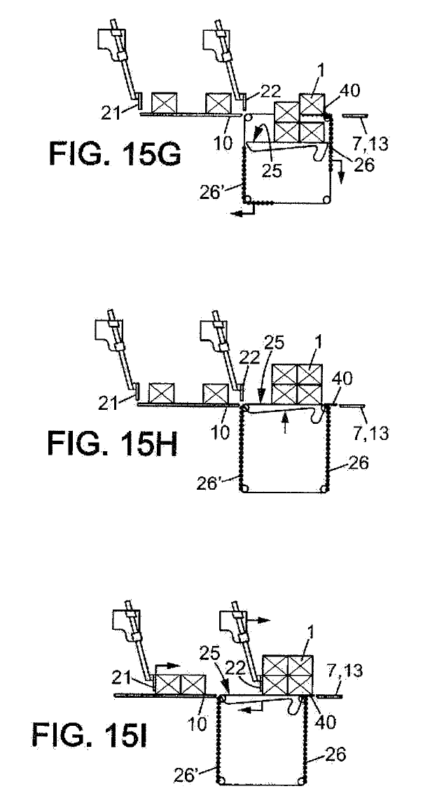

FIGS. 15A to 15I show the different stages in the progress of an operation of preparing and stacking two layers of boxes and removing them towards the table of the palletization station.

The palletization installation shown in FIG. 1 is similar to the palletizer which is described in the abovementioned document FR 2 897 341. This installation, called a palletizer in the remainder of the text can in particular be used for stacking layers of boxes 1 on a pallet 2 and, in particular, boxes 1 containing relatively fragile products, like bottles.

This palletizer comprises:
a zone marked 3 which constitutes a preparatory zone at which the arrival of the boxes 1, then their grouping together in the form of rows of boxes and then their grouping together in the form of layers of boxes 1, take place,
a zone marked 4 which constitutes the actual palletization zone and which comprises a palletization station 5 at which the layer or layers of boxes 1 are placed on a pallet 2,
arrangements for the circulation of the empty pallets and of the loaded pallets.

The pallets 2 can be conveyed to the palletization station 5 in different ways. In the embodiment represented in FIGS. 1 and 2, the pallets 2 are conveyed to a level which is situated below the level of the arrival of the boxes 1 and the level of the preparation of the layers of boxes 1, i.e. below the level of the preparation zone 3.

The pallets 2 are introduced into the palletizer by means of a conveyor 6 which is situated at ground level. The preparatory zone 3 is situated above the conveyor 6 for conveying the pallets 2, as well as the depositing and palletization table 7, which table 7, sometimes called a deck, is vertically moveable in order to deposit the layer or layers of boxes 1 on the pallet 2, at the palletization station 5.

The boxes 1 are introduced into the preparatory zone 3 of the palletizer by a supply conveyor 8 on which they are oriented before arriving at the preparation station 9 where they are grouped together on a table 10 in the form of (a) group(s) of boxes 1 or in the form of one or more rows, which rows are arranged transversally with respect to the subsequent direction of circulation of the boxes 1 towards the palletization station 5.

The boxes 1 are grouped together on the preparation table 10 by means of an abutment 11 which is fixed to the downstream end of said table 10.

The groups or rows of boxes 1 are then moved towards the station 12 for preparing the layers of boxes. At this preparation station 12, the boxes 1 constituting each layer of boxes 1 are pressed, as described in detail below, so as to prepare a layer which is calibrated according to the format of the pallet 2 and according to the scheme of distribution of said boxes on the latter.

Under normal circumstances, i.e. outside the pallet-changing operations etc., each layer of boxes 1 can be transferred directly from the layer-preparation station 12 towards the palletization table 7 which, progressively, deposits these different layers on the pallet 2, which table 7, of the symmetrical opening type, comprises a first panel 13 which, with appropriate means, transfers half of the layer onto a second panel 14 and said layer is deposited on the pallet 2 as described in detail in the abovementioned document FR 2 897 341, by retracting said panels 13 and 14.

The transfer of the groups or rows of boxes 1 then of the layers of boxes from one station to the other is also carried out by means of pushers 20, as in the document referred to above.

These pushers 20 are represented diagrammatically in FIG. 2. A first pusher 20, provided with a plate 21, allows the transfer of the groups or rows of boxes 1 towards the layer-preparation station 12 and a second pusher 20, provided with a plate 22, is used to transfer the layer of boxes 1 towards the palletization table 7 and in particular to push it onto the large retractable panel 13 of this table 7.

All these elements are described in the abovementioned document FR 2 897 341 for palletizing successive layers of boxes 1 by depositing these different layers on the pallet 2.

As indicated previously, the time taken for the preparation of a layer of boxes 1 is clearly less than the time needed to remove the pallet 2 which is full and to convey a new pallet 2 to the palletization station 5.

Thus, in order to account for the time which corresponds to the operations which take place at the palletization station 5, such as changing pallets, inserting interlayers or also vertical alignment, or jogging of the layers, the station 12 for preparing the layers of boxes is arranged in order to prepare layers of boxes 1 that it retains so as to delay the movement of these layers of boxes 1 towards said palletization station 5.

This station 12 for preparing the layers of boxes comprises a device 24 for preparing and stacking layers of boxes 1, which device 24 is arranged so as to carry out a kind of temporary storage of said boxes 1 by stacking several layers of boxes 1 on top of each other, two or more according to requirements, and this operation of forming layers of boxes and stacking these layers of boxes is envisaged to last long enough to cover the time needed for the various operations which take place at the palletization station 5.

In order to carry out this operation of preparing layers of boxes 1 and stacking at least two layers, the buffer device 24 comprises at least two tables which, in turn, receive the groups or rows of boxes 1 in order to form a layer of boxes 1.

In the embodiment shown diagrammatically in the different figures, the buffer device 24 comprises a main table 25 which is arranged in order to carry out a superimposition of two layers of boxes 1; this device 24 can however, without altering the nature of the invention, be arranged so as to allow the superimposition of more than two layers of boxes as a function of the rates and of the time needed to complete the various operations which take place at the palletization station 5.

FIG. 2 shows the arrangement of the buffer device 24 which is shown with several tables: the main table 25 and another table 26; the main table 25 is in retracted position under the table 26; in fact this table 26 has taken the place of the main table 25; another table 26′, described in detail below, is positioned under the main table 25.

For an operation which does not require stacking, i.e. during the setting up of the layers following each other on the pallet 2, it is the table 25 which ensures the preparation of the layers and which ensures the continuity between the table 10 for preparing groups or rows of boxes 1 and the palletization station 5.

Outside the periods of retention of the layers of boxes 1, this table 25 is used as the main table for forming each layer of boxes 1 which, once prepared, is quite simply transferred towards the palletization station 5, on the deposit table 7, in order to fill the pallet 2 which is situated at said palletization station 5, as described in detail in the abovementioned document.

The second layer-preparation tables 26, 26′ are used during the progress of the various operations to be carried out at the palletization station 5. These second interim preparation tables 26, 26′ operate when it is necessary to delay sending the boxes 1 towards the palletization station 5; the different layers prepared by means of these interim tables 26, 26′ are kept at the layer-preparation station 12, and they are stacked on top of each other and all calibrated according to the palletization scheme; they are substituted, in turn, for the main table 25.

In FIG. 2, the main table 25 for preparation of the layers of boxes 1 is positioned below the level of the interim table 26. This main table 25 also appears in FIG. 3, but in the high position, for the preparation of a layer of boxes and it appears in FIG. 4, as in FIG. 2, but in the low position, i.e. in a position where, normally, it bears a layer of boxes 1, as represented by fine dot-and-dash lines.

The interim table 26 which appears in FIG. 2 and FIG. 4 is in operation; it is in the operative position in order to allow the preparation of an additional layer; it takes the place of the main table 25 when the latter is on standby, i.e. when it cannot deliver the layer of boxes 1 that it has prepared and when it is, in this case, retracted in the low position.

These tables 25, 26 and 26′ ensure a continuity between the table 10 for preparing the groups or rows of boxes and the panel 13 of the palletization table 7 which receives the layer of boxes 1 prepared for palletization.

The main table 25 is constituted, as in the abovementioned patent FR 2 897 341, by a deck in the form of an endless belt which is motorized by a geared motor and, as described in detail in this patent, the movement of this belt is coordinated with that of the plate 22 of the pusher 20.

The belt of the table 25 is guided in a support 27 which is itself borne by a cradle 28 arranged transversally with respect to the direction of advance of said belt of the table 25. This cradle 28 is vertically moveable, guided in a general chassis 29 and it is maneuvered by a mechanism which is described in detail below.

The table 26 and the table 26′, both interim, are presented in the form of flexible panels. These panels are constituted by rollers 30 with a small diameter, as shown in FIGS. 5 and 6. These rollers 30 are borne, at their ends, by endless chains 31, which circulate in parallel and vertical planes arranged at the edge of the layer-preparation station 12.

Each chain 31 is tensioned on pulleys marked from 32 to 35; which pulleys are positioned at the angles of a frame 36 which is firmly fixed to the general chassis 29 and, more particularly, with the posts 37 and 38 which form, on each side of the station 12, the structure of this chassis 29. Each frame 36 is arranged so as guide a chain 31 around the main table 25, as also shown in FIG. 7.

The table 25 has a length L which is close to the distance which separates the row-preparation table 10 and the palletization table 7 and, more particularly, to the dimension F of the window which extends between the slider beds 39 and 40, which slider beds 39 and 40 form, respectively, the junction between, on the one side, said table 10 and the main table 25 and, on the other side, downstream, said table 25 and the panel 13 of the palletization table 7.

When, as shown in FIG. 4, it is the interim table 26, or 26′, which forms the junction between the table 10 and the panel 13 of the palletization table 7, the length of this interim table 26, constituted by the rollers 30, corresponds substantially to the length L of the surface of the main table 25, also close to the distance F which separates the slider beds 39 and 40.

These tables 25 and 26, 26′, are moveable, as described in detail below, in the direction of movement of the boxes 1, i.e. in a direction from the table 10 for preparing the groups or rows of boxes towards the palletization table 7 in order to carry out a longitudinal confinement of said boxes 1 which constitute a layer, against an abutment which corresponds to the slider bed 40 as described in detail below.

The cradle 28 of the main table 25 is driven in a sequential upward and downward movement, by means of a servomotor 45 which makes it possible to control and manage this ascending movement between a high position for preparing the layer of boxes and one or more low standby positions for receiving one or more additional layers of boxes 1.

The tables 26, 26′, are moveable, maneuvered by means of the chains 31 using a geared motor-type motor component 46; these tables 26 and 26′ rotate around the main table 25. Furthermore, as described in detail hereafter, the movement of the tables 26, 26′ also makes it possible to press the boxes 1 in the longitudinal direction during the preparation of a layer; this layer is in fact calibrated, as also described in detail below, before being deposited on the layer which is standing by on the main table 25.

The longitudinal confinement of the boxes 1 of each layer is carried out in cooperation and by means of an abutment which extends transversally with respect to the direction of advance of said boxes 1 towards the palletization station 5. This transverse abutment 40 in fact corresponds to the slider bed 40 and it fulfils a double function: it in fact constitutes the slider bed 40, as described in detail above, in order to form the junction between the main table 25 and the panel 13 of the palletization table 7 and it plays this role of transverse abutment, also marked 40, in order to carry out the longitudinal confinement of the layer of boxes 1. This slider bed or abutment 40 is described in detail below in connection with FIG. 14.

This slider bed or abutment 40 therefore allows the longitudinal calibration of the layer of boxes 1 by means of the advancing movement of the groups or rows of boxes 1, when this layer is borne by the main table 25 or, depending on the case, by the interim table 26 or 26′; all these tables 25, 26 and 26′ are moveable at a speed chosen for gently carrying out a longitudinal calibration.

The transversal calibration of each layer of boxes 1 is carried out by means of cleats 47 situated on each side of the layer-preparation station 12, above the level of the table 25 and of the table 26, 26′ depending on the case. These lateral cleats 47 are borne by a system of sliders 48 which cooperate with runners arranged on a casing 49 details of which are given below in connection with FIG. 13.

Given the movement of the interim table 26 and its installation on chains 31 which rotate around the main table 25, said chains 31 bear, as indicated previously, two tables 26 and 26′ which are opposed, separated from each other by a distance which corresponds at least to the length F of the window which extends between the slider beds 39 and 40.

In FIG. 2, the two tables 26 and 26′ are shown in opposition; the table 26 is in the operative position for receiving groups or rows of boxes 1 and the table 26′ is in the inoperative position below the main table 25, but above the conveyor 6 on which the pallets 2 circulate. These two tables 26 and 26′ form, with the chains 31, a kind of noria which turns in a very precise direction, which direction corresponds, when they are in the operative position for receiving a group of boxes 1, to the direction of advance of this group of boxes and to the subsequent direction of advance of the layer or layers of boxes 1 towards the palletization station 5.

In order to carry along the boxes 1 and exert a pressure on them, when they are supported on the abutment 40, as shown in FIG. 4, the rollers 30 of the tables 26, 26′ are mounted on the chains 31 with at least one free wheel, as shown in FIG. 5.

Each roller 30 is constituted by a tube with a small diameter, of the order of 30 mm, and this tube comprises at each of its ends a welded end piece 50, for example, each end piece 50 comprises a journal 51 in a bearing 52 and, on one side, the journal 51 is extended in order to cooperate with a free wheel 53.

The bearings 52 are each housed in a socket 54 which acts as a support, which socket 54 is firmly fixed, by means of a right-angle bracket 55, to a link of the chain 31, on each side of the station 12 for the preparation of the layers of boxes 1. One of the sockets 54 contains, in addition to the bearing 52, the free wheel 53 and the other socket 54 is arranged in order to immobilize the roller in translation by means of the corresponding bearing 52 which is firmly fixed to the end piece 50.

The sockets 54 which bear the ends of the rollers 30 are guided, on each side, over a longitudinal block 56 which extends between the upper pulleys 34 and 35, which block 56 is borne by a right-angle bracket 57 which is firmly fixed to the corresponding frame 36. These blocks 56, made of resistant material with a low coefficient of friction, support the weight of the layer of boxes 1 when it is in preparation on one of the interim tables 26, 26′.

The cradle 28 of the main table 25 is guided over each pair of posts 37, 38, and it is vertically moveable by means of a maneuvering mechanism which comprises a chain-lifting system, arranged in each of said posts 37, 38 the section of which is U-shaped with flanges.

FIG. 8 shows a pair of posts 37, 38 and the maneuvering means which make it possible to move the cradle 28, vertically, between several positions, depending on the number of layers of boxes 1 which are capable of being deposited on the main table 25.

The cradle 28 is guided, for example, over the post 38 by means of guide rollers 58 arranged laterally and it is also guided over the bottom of each post 37, 38, by means of the guide rollers 59, respectively.

The vertical movement of the cradle 28 is carried out by means of chains 60 which are respectively fixed on said cradle 28 and which are tensioned between pulleys: pulleys 61 and 62 arranged respectively at the top and towards the bottom of the posts 37 and 38.

These two chains 60 are moveable under the effect of the servomotor 45 mentioned previously, which servomotor 45 drives, by means of belts or chains 66 and 67, said chains 60 in order to raise or lower the cradle 28 which bears the main table 25.

FIG. 9 shows the installation of the motorization systems for the cradle 28 and in particular for the chains 60 which are firmly fixed to this cradle 28. It again shows the servomotor 45 which drives, by means of the belts or chains 66 and 67, shafts 68 and 69 on the ends of which the pulleys 62 driving the chains 60 are installed.

This FIG. 9 also shows the geared motor 46 which drives the chains 31 of the noria on which are positioned the rollers 30 which form the interim tables 26 and 26′. A shaft 71 extends between the chains 31 which are situated on each side of the station 12 for preparing the layers of boxes 1, which shaft 71 bears the pulleys 32 driving said chains 31 and it is guided in bearings arranged at the lower part of the frames 36 which form, with the chassis 29, the structure of the noria.

The servomotor 45 is borne by a support 74 arranged in the central part of the station 12 at the lower part of the frames 36. This support 74 rests on cross members 75 which link the posts 37, on the one hand, and the posts 38, on the other hand.

FIG. 10 is a partial front view of the chassis 29, which chassis 29 bears and guides the cradle 28 on which the support 27 of the main table 25 is placed. The cradle 28 is maneuvered on each side by the chains 60 which extend from the upper part of the posts 37, 38, up to a level which is situated substantially above the level of the cross members 75 which extend between the pairs of posts 37, 38 and which also form the structure of the chassis 29.

FIG. 10 again shows the cradle 28 which bears the support 27 of the main table 25. This cradle 28 is guided over the chassis 29 and in particular over the bottom of the posts 37, 38, by means of the guide rollers 59 and it is maneuvered on each side by means of the chains 60, as described in detail above.

The lateral cleat 47 which is borne by the casing 49 and the sliders 48 is situated at the upper part of the post 38; the casing 49 is fixed to the upper part of the post 38 and the assembly is described in detail below in connection with FIG. 13.

FIG. 11 shows a partial front view of a frame 36 of the noria, arranged facing the chassis 29 and posts 37 and 38 in FIG. 10.

This FIG. 11 again shows the servomotor 46 which drives the shaft 71 by means of a belt or chain 76. There can also be seen, in this FIG. 11, the block 56 which is arranged at the upper part of the frame 36 in order to guide and support the sockets 54 of the rollers 30. A block 77 is also arranged at the lower part of the frame 36, in order to guide and support the rollers 30 which constitute the interim tables 26, 26′, when they are in the inoperative position, at the lower part of said frame 36, below the main table 25 and above the conveyor 6 which delivers the pallets 2 to the palletization station 5.

FIG. 12 shows a partial front view of the chassis 29 with the frame 36 of the noria in the normal position, installed on this chassis 29. This frame 36 rests, at its lower part, on the cross members 75 which are fixed to the posts 37 and 38 constituting the support 29 and it comprises, at its upper part, lugs 78, in the form of right-angle brackets, which make it possible to fix it to the upper part of said posts 37 and 38.

This chassis 29 forms, viewed from the front, a kind of U open at the top, which top part comprises, on each of the posts 38, the lateral cleats 47 which make it possible to press the boxes 1 and calibrate the layer in the transversal direction in order to make it correspond to the palletization scheme and in particular to the perimeter of the pallet 2, for example. These cleats 47 are borne, as shown in FIG. 13, by a pair of sliders 48 which cooperate with runners 79 arranged laterally on the casing 49, which casing 49 is fixed to the upper part of each of the posts 38, i.e. posts which are situated on the side of the palletization station 5.

A cylinder 80 is interposed between the casing 49 and the cleat 47 in order to move the latter transversally with respect to the direction of advance of the boxes 1 on the table 25 or the table 26, 26′ depending on the case, at the station 12 for preparing and stacking the layers of boxes 1.

These cleats 47 are situated substantially set back from the abutment 40 which also acts as a slider bed. This abutment 40, shown in FIG. 14, extends over the entire width of the station 12, downstream of the cleats 47; it is articulated on the frame 36 of the noria and it is borne, on each side, by a kind of arm 85 in the form of a right-angle bracket. This arm 85 is mobile about a pin 86 which corresponds, for example, to the pin of the pulley 34 of the chain 31, on each frame 36 of the noria, which arm 85 is maneuvered by means of a cylinder 87 in order to cause the abutment to pass from its operative abutment position 40 to its operative slider bed position 40, depending on the case, and vice versa.

The abutment 40 also acts to provide security during the transfer of the boxes 1, when they are pushed by the plate 22 of the pusher 20; in fact, when the boxes 1 are moved into place by the plate 22, in particular on the interim table 26, 26′, these boxes 1 are borne by the rollers 30 which are free to rotate in the direction which corresponds to the advance of said boxes 1 towards the palletization table 7. The abutment 40 can therefore stop the boxes 1 which would tend to continue on their path and go beyond the interim table 26, 26′.

The device 24 for preparing and prestacking layers of boxes 1 is also presented in the form of a module which can be inserted into a palletization installation once this installation requires temporary storage of the boxes 1 by stacking several layers of boxes on top of each other, two or more according to need, in order to cover the time needed for the various operations which take place at the palletization station 5.

FIG. 15 diagrammatically illustrate from A to I, the different stages which make it possible to carry out a stacking of layers of boxes 1 at the layer-preparation station 12, in order to take up the down time which results from the different operations carried out at the palletization station 5.

FIG. 15A shows a pair of rows of boxes 1, pushed by the plate 21 of the pusher 20, from the table 10 of the station 9 for preparing the rows of boxes 1 up to the main table 25 which is in the high position, i.e. in the operative position for preparing a layer of boxes 1.

In this FIG. 15A, the presence of the transverse abutment 40 which is in the operative abutment position can be seen. The interim table 26 and the table 26′ of the noria are both in the inoperative position, forming vertical walls on each side and below the level of the main table 25.

FIG. 15B shows the operation of the main table 25 and in particular its movement of advance which makes it possible, in collaboration with the abutment 40, to group together the rows of boxes 14 and to calibrate, in the longitudinal direction, the layer of boxes 1 on said abutment 40. During this longitudinal calibration, and transversal calibration operation using the cleats 47 which are not shown in this figure, the plate 21 returns to the starting position in order to pick up the new groups or rows of boxes 1 which are formed on the preparation table 10.

FIG. 15C shows the vertical movement of the main table 25 from its high position for preparing the layer to its low position standing by to receive another layer of boxes 1.

Still in this FIG. 15C, it can be seen that the plate 21 is in position for picking up the rows of boxes 1 in order to convey them to the station 12 for preparing a new layer of boxes 1.

FIG. 15D shows the moving into place of the interim table 26 which will fill the window left empty by the main table 25. At the same time, the plate 21 picks up the new rows of boxes 1 and, as shown in FIG. 15E, it positions them on the interim table 26 which is positioned in the space left free by the main table 25.

The rows of boxes 1 placed on the interim table 26 advance towards the abutment 40 under the effect of the movement of this table 26 which is, it will be recalled, constituted by rollers 30 mounted with a free wheel 53. In its movement, the interim table 26 carries the boxes 1 along and it confines these boxes 1 on the abutment 40 and, as it moves, as shown in FIG. 15G, this interim table 26 drops the layer of boxes 1, which layer is positioned, by gravity alone, on the previous layer which is borne by the main table 25.

FIG. 15F shows that, during the preparation of the second layer of boxes 1 and during its deposition on the previous layer, the plate 22 of the pusher 20 is moved in order to be put into the operative position for picking up the two layers of boxes 1 which have just been prepared and which are superimposed on the main table 25.

In FIG. 15H, this main table 25 is passed from its low position to its normal high position, i.e. to the level of the table 10 and palletization table 7. In order to avoid too violent a docking between the plate 22 and the layer of boxes 1, it can be seen in FIG. 15I that the main table 25 is also set in motion, as described in detail elsewhere in the abovementioned document FR 2 897 341, in order to start the boxes moving towards the palletization table 7 and set these layers of boxes 1 in motion in order to avoid too violent a docking between the plate 22 and all of these boxes 1 which represents a sometimes significant mass in motion. It is the plate 22 which conveys the layer into the optimum position on the panel 13 of the palletization table 7. During this removal of the different layers of boxes 1, it can be seen, still in FIG. 15I, that the plate 21 has picked up the new rows of boxes 1 in order to convey them, with no loss of time, onto the main table 25 recommencing its cycle.

In order to be able to remove the layers of boxes 1 which have been prepared on the main table 25, as shown in FIG. 15H, the abutment 40 passes from its operative abutment position to the operative slider bed position 40 in order to form the junction between the main table 25 and the panel 13 of the palletization table 7. This position of the slider bed 40 is maintained throughout the transfer time of the layers of boxes 1, as shown in FIG. 15I. The abutment 40 is repositioned immediately after the complete removal of the layers of boxes 1, in order to allow the calibration of the rows of boxes conveyed by the plate 21 and form a new layer of boxes 1 on the main table 25. According to need, the main table 25 can receive several layers of boxes which are stacked on top of each other standing by in order to be transferred to the palletization table 7.

The method for prestacking several layers of boxes 1, in order to delay the operation of palletization of these different layers, therefore consists of:
preparing a layer of boxes on the main table 25 from a previously formed group of boxes 1;
calibrating this layer of boxes according to the palletization scheme and putting it into the format of the receiving pallet 2, on said main table 25;
vertically retracting said main table 25, by a height substantially greater than the thickness of the layer of boxes 1;
installing an interim table 26, 26′, in the space left free by said main table 25.
conveying a new group of boxes 1, onto said interim table 26, 26′ and calibrating it in the same way as the previous layer and vertical to this previous layer;
retracting said interim table 26, 26′ while keeping the corresponding layer of boxes 1 framed in order to deposit it directly on the previous layer which is arranged on said main table 25;
once there is no longer any need for delay, conveying the main table 25 to the level of the palletization table 7, with its different superimposed layers of boxes 1; and,
transferring said superimposed layers of boxes 1 to said palletization station 7 to be deposited on the new pallet 2.

The method also consists of simultaneously transferring the superimposed layers of boxes 1 towards the palletization station 7 and the moving into place of new rows of boxes 1 on the main table 25 for forming the initial layer of boxes.

In order to carry out the calibration of each layer of boxes 1 at the layer-preparation and prestacking station 12, the method also consists of:
stopping the boxes 1 on the transverse abutment 40 situated at the downstream end of said station 12 in order to longitudinally press said boxes 1 by means of each layer-preparation table 25 or 26, 26′,
transversally pressing the boxes 1 constituting each layer, by means of lateral cleats 47 which border said layer-preparation station 12 and which are moveable above the table (25, 26, 26′), which bears the corresponding layer and,
longitudinally pressing said boxes 1 by means of the corresponding table 25, 26, 26′, under the effect of the adherence between the different boxes 1 and said corresponding table, by a longitudinal movement of said corresponding table in a direction from the table 10 for preparing the rows of boxes towards the palletization station 7.

1.-9. (canceled)

10. A Palletizer comprising, on a same general chassis:
a preparation zone for preparing layers of boxes, which preparation zone comprises:
a first conveyor for conveying boxes,
a group or row-preparation station for preparing groups or rows of boxes,
a layer-preparation station for preparing each layer of boxes,
a palletization zone for an actual palletization which comprises a palletization station and a deposit table,
pushers for moving said boxes and layer(s) of boxes from said preparation zone towards said palletization zone and,
a second conveyor which conveys empty pallets to said palletization station, the palletizer further comprising, at said layer-preparation station:
a main table which is vertically moveable from a high position for preparing a first layer of boxes to a low position standing by for another layer of boxes, which main table is constituted by a motorized endless belt, which is used for setting the boxes in motion and pressing the boxes against a retractable transverse abutment, in order to calibrate said layer of boxes, in a longitudinal direction of circulation of said boxes on said main table,
lateral cleats cooperating with said retractable transverse abutment for calibrating said layer of boxes at said layer-preparation station,
at least two interim tables each capable of taking the place of said main table when said main table is in said low position with at least one layer of boxes, which interim tables are horizontally moveable, guided between an operative position of occupation of a window left free by said main table, in order to receive groups or rows of boxes and allow a new layer of boxes to be formed, and an inoperative position which said interim tables reach by being retracted and separated from said new layer of boxes, which is deposited on said layer of boxes present on said main table by gravity alone, as an interim table which is in operation is retracted,
said pushers comprising a first pusher which moves groups or rows of boxes between said group- or row-preparation station and said layer-preparation station, and
a second pusher which moves the layer or layers of boxes between said layer-preparation station and said palletization station.

11. The palletizer according to claim 10, further comprising at said layer-preparation station, two identical interim tables which are each constituted by a flexible panel produced with rollers with a small diameter mounted on a free wheel, which interim tables are mounted opposite each other, on endless chains and the assembly of said interim tables and endless chains forms a noria, which endless chains are arranged laterally, on each side of said layer-preparation station, guided in a frame borne by said general chassis which extends around said main table, and a free space between said two interim tables corresponds at least to a length of a receiving surface area of said main table in order to allow said main table to pass through when said main table is placed in said operative position for receiving rows of boxes, which endless chains are moved sequentially forwards in a direction which corresponds to a direction of advance of said layers of boxes towards said palletization station.

12. The palletizer according to claim 11, wherein said rollers of each said interim table, are mounted on bearings comprising a free wheel so as to set said boxes in motion and press said boxes against said transverse abutment in order to automatically calibrate a layer of boxes according to a palletization scheme, as said rollers are retracted during the depositing of said layer of boxes on said layer of boxes which is situated on said main table.

13. The palletizer according to claim 10, further comprising means for calibrating each layer of boxes according to a palletization scheme, which means for calibrating are constituted, on the one hand, by a retractable abutment which is arranged transversally with respect to a direction of travel of said boxes on said layer preparation station for preparing and stacking the layers of boxes, at the downstream end of said layer-preparation station and, on the other hand, by cleats arranged laterally on each side of said layer-preparation station.

14. The palletizer according to claim 13, wherein said transverse abutment is arranged and positioned so that, in said inoperative position, said transverse abutment acts as a slider bed joining said main table and said deposit table of said palletization zone.

15. The palletizer according to claim 10, wherein said main table comprises a support which is borne by a cradle, which cradle extends transversally beyond noria frames of said noria, and said cradle is guided vertically on posts which form part of said general chassis on which said noria frames are fixed, and said cradle is maneuvered in the vertical direction by means of a mechanism integrated into said posts of said chassis, which mechanism is constituted by further chains firmly fixed to said cradle, which further chains are arranged in said side posts and are driven by a common servomotor.

16. A method for prestacking several layers of boxes in order to delay an operation of palletizing said several layers on a palletizer constituted, on a same general chassis by:
a preparation zone for preparing layers of boxes, which preparation zone comprises:
a first conveyor for conveying boxes,
a group or row-preparation station for preparing groups or rows of boxes,
a layer-preparation station for preparing each layer of boxes,
a palletization zone for an actual palletization which comprises a palletization station and a deposit table,
pushers for moving said boxes and layer(s) of boxes from said preparation zone towards said palletization zone and,
a second conveyor which conveys empty pallets to said palletization station, the palletizer further comprising, at said layer-preparation station:
a main table which is vertically moveable from a high position for preparing a first layer of boxes to a low position standing by for another layer of boxes, which main table is constituted by a motorized endless belt, which is used for setting the boxes in motion and pressing the boxes against a retractable transverse abutment, in order to calibrate said layer of boxes, in a longitudinal direction of circulation of said boxes on said main table,
lateral cleats cooperating with said retractable transverse abutment for calibrating said layer of boxes at said layer-preparation station,
at least two interim tables each capable of taking the place of said main table when said main table is in said low position with at least one layer of boxes, which interim tables are horizontally moveable, guided between an operative position of occupation of a window left free by said main table, in order to receive groups or rows of boxes and allow a new layer of boxes to be formed, and an inoperative position which said interim tables reach by being retracted and separated from said new layer of boxes, which is deposited on said layer of boxes present on said main table by gravity alone, as an interim table which is in operation is retracted,
said pushers comprising a first pusher which moves groups or rows of boxes between said group- or row-preparation station and said layer-preparation station, and
a second pusher which moves the layer or layers of boxes between said layer-preparation station and said palletization station,
the method comprising:
preparing a layer of boxes on said main table from a previously formed group of boxes;
calibrating said layer of boxes according to a palletization scheme and putting said layer of boxes into the format of a receiving pallet, on said main table;
vertically retracting said main table, by a height substantially greater than the thickness of said layer of boxes;
installing an interim table in the space left free by said main table;
conveying a new group of boxes onto said interim table and calibrating said new group of boxes in the same way as said layer of boxes and vertical to said layer of boxes;
retracting said interim table keeping a corresponding new layer of boxes framed in order to deposit said new layer of boxes directly on said layer of boxes which is arranged on said main table, at a lower level;
once there is no longer any need for delay, returning said main table to the level of said deposit table, with different superimposed layers of boxes surimposed on said main table; and,
transferring said superimposed layers of boxes to said palletization station in order to deposit them on said pallet.

17. The method for prestacking several layers of boxes, according to claim 16, wherein comprising simultaneously carrying out a transfer of said superimposed layers of boxes towards said palletization station and a setting up of new rows of boxes on said main table for formation of an initial layer of boxes.

18. The method for prestacking several layers of boxes, according to claim 17, wherein in order to carry out said calibration of each layer of boxes, the method comprising:
stopping boxes on said transverse abutment situated at a downstream end of said layer-preparation station in order to longitudinally press said boxes by means of said main table or one of said interim tables,
transversally pressing boxes constituting each layer, by means of lateral cleats bordering said layer-preparation station, which cleats are moveable above said main or interim table which bears said corresponding layer and,
longitudinally pressing said boxes by means of said corresponding main or interim table, under the effect of the adherence between the different boxes and said corresponding main or interim table, by a longitudinal movement of said corresponding main or interim table in a direction from a preparation table of said group or row-preparation station for preparing the rows of boxes towards said palletization station.
